(19) United States
(12) Patent Application Publication
(10) Pub. No.: US 2005/0287285 A1
(43) Pub. Date: Dec. 29, 2005

(54) Edible products with reduced oxidation and spoilage

(76) Inventors: Herbert O. Hultin, Rockport, MA (US); Yong Liang, Gainesville, FL (US)

Correspondence Address: FISH & RICHARDSON PC, P.O. BOX 1022, MINNEAPOLIS, MN, 55440-1022, US

(21) Appl. No.: 10/510,928

(22) PCT Filed: Apr. 11, 2003
(86) PCT No.: PCT/US03/11049

§ 371 Date: Aug. 22, 2005

Related U.S. Application Data
(60) Provisional application No. 60/372,247, filed on Apr. 12, 2002.

(51) Int. Cl. A23L 1/31

(52) U.S. Cl. 426/646

(57) ABSTRACT

The invention is based, in part, on the discovery that the addition of cations, such as calcium or magnesium ions, to muscle tissue before solubilization of the muscle proteins enhances removal of membranes, which reduces oxidation and spoilage of the muscle tissue.

### TECHNICAL FIELD

This invention relates to a process for isolating edible protein from animal muscle by removing membranes to reduce oxidation and spoilage of the edible protein.

### BACKGROUND

Low value animal muscle (e.g., from fatty pelagic fish or poultry bone residue) is usually undesirable as a source of food for human consumption. After processing, the isolated protein is often characterized by unattractive textures, dark colors, and strong flavors. Such unfavorable characteristics are often due to membrane lipid oxidation. The problem is particularly acute with fish since their lipids are susceptible to oxidation partly because of the highly unsaturated nature of the fatty acids.

One impediment to implementing many methods of food processing, e.g., protein extraction, on an industrial scale has been the cost of centrifuging solubilized proteins to remove the membranes in industrial equipment. Standard industrial decanter centrifuges typically apply a gravitational force of up to approximately 4,000 g, which is generally ineffective.

### SUMMARY

The invention is based, in part, on the discovery that the addition of specific cations, such as calcium or magnesium ions, and optionally an organic acid, to muscle tissue before solubilization of the muscle proteins can enhance removal of membranes, which significantly reduces oxidation and spoilage of the muscle tissue.

In general, the invention features a method for isolating edible protein compositions from animal muscle by (a) obtaining a mixture comprising minced or ground animal muscle, (b) adding an amount of a polyvalent, food-grade cation to the mixture sufficient to separate cellular membranes from cytoskeletal proteins in the animal muscle, and (c) treating the mixture to reduce the oxidation potential of the separated cellular membranes. The method can optionally include a step of homogenizing the animal muscle.

In this method, the polyvalent, food-grade cations are metallic cations, e.g., calcium and magnesium ions, and the final concentration of calcium and/or magnesium ions in the mixture can be in a range of about 0.1 mM to about 50 mM after the addition of an aqueous solvent such as water. Magnesium and calcium ions can be added to the mixture by, e.g., adding magnesium chloride or calcium chloride, respectively, to the mixture. Following the addition of ions, the mixture can optionally be incubated for a period of time, e.g., from 3 up to 60 minutes, or more, e.g., 5, 10, 15, or 30 minutes.

Treating the mixture can include aggregating at least a portion of the separated cellular membranes in the mixture to reduce the total separated membrane surface area, thereby reducing the oxidation potential. Cellular membranes can be aggregated, e.g., by incubating the mixture after the addition of cations. As another example, cell membranes can be aggregated by adding an acid to the mixture. As still another example, cell membranes can be aggregated by adding an aggregant to the mixture. Suitable aggregants include carrageenan, algin, demethylated pectin, gum arabic, chitosan, polyethyleneimine, spermine, spermidine, calcium salt, magnesium salt, sulfate, phosphate, and polyamine. In certain embodiments of the present invention, steps (b) and (c) are performed simultaneously by adding a sufficient amount of calcium or magnesium ions to cause both separation of cellular membranes and cytoskeletal proteins and aggregation of the membranes.

The method can also include adjusting the pH of the mixture to solubilize at least a portion of the protein in the mixture. Solubilization of the proteins can be performed by lowering the pH of the mixture, e.g., by adding an acid to the mixture. Where an acid is used to adjust the pH of the mixture, an amount sufficient to lower the pH to below about 3.5 can be added. Solubilization can also be performed by increasing the pH of the mixture, e.g., by adding a base to the mixture. Where a base is used to adjust the pH of the mixture, an amount sufficient to raise the pH to greater than about 10.0 can be added.

If the proteins are solubilized, the method can further include separating cell membranes from the solubilized protein. Separation can be performed by centrifugation, e.g., by centrifuging the mixture at from about 500×g to about 10,000×g. Alternatively or in addition, separation can be performed by precipitation. The solubilized protein can be collected from the mixture. An aggregant can be added to aggregate membranes and facilitate their removal following solubilization of the proteins. The aggregant can be, e.g., carrageenan, algin, demethylated pectin, gum arabic, chitosan, polyethyleneimine, spermine, spermidine, calcium salt, magnesium salt, sulfate, phosphate, and/or polyamine.

The method can include dewatering the mixture. Dewatering can performed, e.g., by centrifuging, filtering, and/or pressing the mixture (e.g., using a French press).

In another aspect, the present invention includes a protein composition produced using any of the methods described above.

In another aspect, the invention includes an edible protein composition with reduced oxidation potential that includes minced or ground animal muscle, wherein the composition comprises a cellular membrane content of less than 40% (e.g., less than 30, 25, 20, 10, 5, or 1%) of a cellular membrane content in a sample of the animal muscle as removed from the animal prior to mincing or grinding, or other processing.

In still another aspect, the invention includes an edible protein composition with reduced oxidation potential, which includes minced or ground animal muscle, wherein the composition comprises a cellular membrane content approximately equal to the cellular membrane content in a sample of the animal muscle as removed from the animal prior to mincing or grinding, but wherein at least 60% (e.g., 70, 75, 80, 90, 95, or 99%, or all) of the cellular membranes in the edible protein composition are separated from cytoskeletal proteins and are in aggregated form, as determined using microscopy, e.g., in conjuction with immunological techniques.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DETAILED DESCRIPTION

The present invention relates to a simple, inexpensive, and effective way of treating animal muscle to significantly improve the efficiency of membrane removal from solubilized proteins. The resulting edible protein composition has a significantly reduced oxidation potential, i.e., is relatively free of cellular membranes that can become oxidized and cause spoilage of the composition, is capable of forming a gel, and can be processed into human and animal foods.

Sources of Protein

The process of the present invention can be used to prepare protein isolates from any protein source. For example, any flesh that is recovered from fish, e.g., fillets, or any portion of the fish left after the fillets have been removed (e.g., portions that are not typically used for human food), can be processed. Similarly, there is very little usage of the skeletons of chickens after parts are removed for retail sale. The methods of the present invention can process such chicken and fish parts to produce edible protein suitable for human consumption. Other underutilized muscle sources useful in the methods of the invention include Antarctic krill, which is available in large quantities but is difficult to convert to human food because of its small size.

Representative suitable starting sources of animal muscle for the processes of this invention include fish fillets, deheaded and gutted fish, crustaceans (e.g., krill), mollusks (e.g., squid), chicken and other poultry (e.g., turkey), beef, pork, or lamb. The present invention further contemplates that plant material, e.g., soy, can also be a suitable starting source of protein, and that the methods described herein can be use to produce plant protein isolates.

Treatment of Animal Muscle Prior to Alkaline or Acid Extraction

Animal muscle is processed to separate cellular membranes from cytoskeletal proteins and is then treated to reduce the oxidation potential of the cellular membranes, and thus of the muscle mixture or resulting protein composition. The separated cellular membranes can be treated by incubating the mixture for a sufficient time to allow the membranes to aggregate, thereby reducing the total surface area of the membranes. The addition of acids and/or aggregants enhances this process. Alternatively, the membranes can be removed.

Animal muscle is minced or ground, and is optionally mixed with an aqueous solution. The animal muscle can represent any percentage by weight of the mixture, and can be a relatively low percentage, e.g., less than about 15% (e.g., 5, 6, 8, 10, or 12%) by weight of the mixture. Any aqueous solvent, e.g., water, can be used. In addition, the muscle can be washed with an aqueous solution prior to any mechanical manipulation. The muscle can be substantially diluted in water such that the solubilized protein suspension/solution produced in successive steps of the method is of a low enough viscosity to enhance the removal of lipids or insoluble material, e.g., by centrifugation. Lower viscosity can also aid removal of mixture components using methods other than centrifugation, as described herein. The viscosity of the protein suspension/solution is preferably about 75 mPa·s or less (e.g., about 65, 60, 50, 45, 40, 35, or 30 mPa·s or less). Viscosity is measured, for example, with a Brookfield Model LVF viscometer (Brookfield Engineering, Stoughton, Mass.) as directed by the manufacturer. The manufacturer's supplied conversion chart is then used to calculate viscosity. The animal muscle can be mechanically ground, or minced, or chopped by hand. Thereafter, the minced or ground muscle can be further homogenized to create very fine particles.

After dilution of the animal muscle with water or an aqueous solution to form a mixture, the pH level of the mixture should be about 4 to about 10, e.g., about 6.0 to about 8.0, or about 6.5 to about 7.5, or about 6.8. The pH can be adjusted to get the mixture within this range.

In the next step, polyvalent food-grade cations, e.g., from metal salts, such as calcium ions (e.g., in the form of calcium chloride) or magnesium ions (e.g., in the form of magnesium chloride) are added to the mixture in an amount sufficient to separate cellular membranes from the cytoskeletal proteins in the animal muscle. A single type of ion or mixtures of different types of ions can be added. For example, a mixture of calcium and magnesium ions can be added.

Alternatively or in addition, dry metal salts, e.g., calcium chloride or magnesium chloride, can be added to dry starting material, such as minced animal muscle, or animal muscle in any form that has not yet been mixed with water or an aqueous solvent. Where this is the case, the water or aqueous solvent is added in a step subsequent to the addition of ions, e.g., to prepare a mixture for solubilization of the proteins.

As used herein, the term “food-grade cations” means cations suitable for human consumption. Guidelines for determining whether a source of ions, e.g., calcium chloride or magnesium chloride, is food-grade are provided by the United States Food and Drug Administration (FDA). Adding ions to the mixture as described above causes cellular membranes to separate from their respective cytoskeletal proteins, facilitating removal and/or aggregation of the membranes. Aggregation of the membranes lowers their oxidation potential, e.g., by reducing the oxidizable surface area of the membranes. Removing the separated membranes also reduces their oxidation potential.

When using calcium or magnesium ions in the new methods, the final concentration of calcium and/or magnesium ions in the mixture should be in the range of about 0.1 mM to about 50 mM, e.g., about 1 mM to about 45 mM, about 10 mM to about 40 mM, about 20 mM to about 35 mM, or about 25 mM to about 30 mM. It is also contemplated that concentrations of greater than 50 mM can be used. When ions are added to dry starting material, the final concentration of ions in the mixture is measured following creation of the mixture, i.e., following addition of water or aqueous solvent to the dry starting material. Skilled practitioners will appreciate that the amount of ions present in a mixture is best expressed in terms of molarity because this measurement expresses the final concentration of reactive ions in the mixture, i.e., the amount of ions available to cause separation of cellular membranes from cytoskeletal proteins.

Calcium or magnesium chloride can be obtained from any source, e.g., a commercial source that supplies such compounds for use in foods, or for medical, experimental, or industrial uses.

Optionally, the mixture can be incubated for a period of time following the addition of ions to the mixture. The mixture can be incubated for any period, e.g., less than about 1 minute to about 180 minutes, e.g., about 5 to about 150 minutes, about 10 to about 120 minutes, about 20 to about 90 minutes, or about 30 to about 60 minutes. In various embodiments of the present invention, the incubation period is about 0, 3, 5, 10, 30, or 60 minutes long. The present invention contemplates that even periods of time longer that 180 minutes can be utilized.

Optionally, an aggregant can be added to the mixture to cause/facilitate aggregation of the cellular membranes. Suitable polymer aggregants include carrageenan, algin, demethylated pectin, gum arabic, chitosan, polyethyleneimine, spermine, and spermidine. For example, chitosan can be added to the protein in an amount ranging from 0.1 to 1.0% by weight of the protein. Other aggregants include salts, such as a calcium and magnesium (which can be added in amounts additional to those described above for causing separation of cellular membranes and cytoskeletal proteins), sulfate and phosphate (which can be added in amounts equal to those described above for magnesium and calcium for causing separation of cellular membranes and cytoskeletal proteins), and polyamine. Skilled practitioners will recognize that a sufficient amount of calcium and/or magnesium salts can be added during a the first addition of these calcium and/or magnesium ions (described above) to cause both cellular membrane/cytoskeletal protein separation and aggregation of the membranes.

Optionally, an organic acid, such as citric acid, or citrate salt, is added to the mixture before, during, and/or after the addition of ions to the mixture. Further, citric acid can be added before, during, and/or after any period of incubation of the mixture with calcium or magnesium chloride, and can be added to the mixture such that the final concentration of citric acid in the mixture is from about 0.001 mM to about 10 mM, e.g., from about 0.01 mM to about 9 mM, about 0.1 to about 5 mM, about 0.5 to about 2 mM, e.g., about 1 mM. Alternatively or in addition, other organic acids can be used in the methods of the present invention, e.g., malic, maleic, and/or tartaric acid, fumaric, or salts thereof. Addition of an organic acid to the mixture during the process improves the effect of adding ions to the mixture, causing greater and more rapid separation of cellular membranes from cytoskeletal proteins. Further, the present invention contemplates that inorganic acids, e.g., sulfuric or any other polyanionic acid, can be used in addition, or alternative to, the use of an organic acid.

When ions and an organic acid, e.g., citric acid, are used in combination as described above, the process can be terminated following the addition of ions and the acid to the mixture, because the cell membranes will have separated and aggregated. The mixture can then be dewatered using any method known in the art, e.g., by pressing, to remove/reduce the water content of the mixture. Pressing can be performed, for example, using a French press or by centrifuging the mixture. As another example, the mixture can be filtered to remove water.

Alternatively, whether or not an organic acid is added to the mixture, the pH of the mixture can then be adjusted to an alkaline pH or an acidic pH for solubilization of the proteins and/or removal of the membranes from the mixture, as described in further detail below.

Acid and Alkaline Extraction of Proteins

To solubilize a portion, e.g., at least 50%, e.g., at least 60, 70, 75, 80, 85, or 90%, of the animal protein by weight, the pH of the mixture is increased or decreased. For example, the pH of the mixture can be increased, e.g., to greater than about 10.0 (e.g., about 10.0 to 11.0 or 11.5, or about 10.5). Alternatively, the pH of the mixture can be decreased, e.g., to below about 3.5 (e.g., about 3).

Protein denaturation and protein hydrolysis is a function of temperature and time in solution, with increasing temperature and time in solution promoting protein denaturation and hydrolysis. The aqueous composition also may contain components such as preservatives, which protect proteins from degradation. In addition, the ionic strength of the solution can be adjusted to avoid protein precipitation.

In the acid and alkaline extraction methods, any acid or base, respectively, that does not contaminate the final product can be used to lower the pH of a mixture. For example, organic acids (e.g., malic acid or tartaric acid) or mineral acids (e.g., hydrochloric acid or sulfuric acid) are suitable. Citric acid which has a favorable pKₐ value can provide buffering capacity at pH 3 and pH 5.5. Acids that have significant volatility and impart undesirable odors, such as acetic acid or butyric acid, are undesirable. Likewise, any of several bases, e.g., NaOH, can be used to raise the pH of the mixture. Polyphosphates are suitable, since they also function as antioxidants and improve the functional properties of the muscle proteins.

Since the control of the pH of a mixture can often be difficult, the mixture can include a buffer that maintains an acidic target pH value or a basic target pH value. Given a target pH, the choice of buffer is within the skill in the art of food science. Buffers suitable for a target pH in the range of 8.0 to 9.0 include glycine, arginine, asparagine, cysteine, carnosine, taurine, pyrophosphate, and orthophosphate. Buffers suitable for a target pH in the range of 5.5 to 6.5 include histidine, succinate, citrate, pyrophosphate, and malonate. Buffers suitable for a target pH in the range of 2.0 to 2.5 include alanine, glutamic acid, citric acid, lactic acid, phosphoric acid, or pyruvic acid.

Removal of Cellular Membranes

Optionally, cellular membranes can be removed physically from the mixture to reduce their oxidation potential (and thus the oxidation potential of the entire mixture). Cellular membranes are removed, e.g., by centrifugation, after the proteins in the mixture have been solubilized as described above.

For example, the mixture can be centrifuged so that the charged membrane lipids are separated from an aqueous phase, which is collected by, for example, decanting the aqueous phase. Using the new methods, the mixture can be centrifuged, e.g., at from less than 500×g to about 10,000×g, or higher, e.g., at 1000×g, 2000×g, 3000×g, 4000×g, 6000×g, 7000×g, 8,000×g, or 9,000×g. Several layers can form after centrifugation. At the bottom, the charged membrane lipids and any remaining residue are pelleted. The percentage sediment weight can be less than 20% (e.g., less than 10%), and higher sediment percentage may indicate that some of the desirable protein has been removed with the undesirable lipids. Percentage sediment weight is defined as the weight of pellet after centrifugation divided by the total homogenate mixture weight. Above the pellet is an aqueous layer containing the solubilized protein. At the top, the neutral lipids (fats and oils), if any, float above the aqueous layer. The neutral lipids can be removed with a pipette before decanting the aqueous phase. Intervening layers can also be present depending on the source of muscle. For example, a gel of entrapped water containing solubilized protein can form between the aqueous layer and the pellet. This gel can be kept with the aqueous layer to increase protein yield.

Of course, in industrial applications, the aqueous phase (and other phases, if desired) can be removed during centrifugation using a continuous-flow centrifuge or other industrial scale machinery.

Methods other than centrifugation can be used to separate the membrane lipids from the aqueous phase. For example, a variety of filtration devices are available to the skilled artisan, depending on the size and volume of the material to be separated. If the membranes are not aggregated, a microfiltration apparatus is suitable and can be used for separating molecules having molecular weights in the range of 500,000 to 20 million. If the membranes are aggregated, particulate filtration may be suitable. These filtration units typically operate under pressure in the range of 2 to 350 kPa. In addition, cationic exchange membranes (sc-1) and anionic exchange membranes (sa-1) are suitable for removing membrane lipids from the mixture. In addition, various filtration methods can be used to select for or against muscle proteins of a particular size.

In some circumstances, an HF-lab-5 ultrafiltration unit (Romicon, Inc., Woburn, Mass.) can be used with a feed tank having an immersed cooling coil to maintain a relatively constant temperature. A cross flow process, which has the advantage of removing filter cake continuously, can also be used. To recover water or lower the salt content of the mixture, filtration membranes can be used with electrodialysis to drive out ions from the mixture. For this particular purpose, a stackpack unit (Stantech, Inc., Hamburg, Germany) can be used. This unit contains several cell pairs sandwiched between two electrode compartments.

Removal of membranes can also be facilitated by subjecting a mixture to high pressure, using, e.g., the MPF 7000 device (Mitsubishi Heavy Industries, Ltd.) or the High Pressure ACB 665 device (Gec, Alsthom; Nantes, Frances). High pressure treatment, accompanied by the proper temperature treatment, has the added benefit of killing known pathogens, in addition to aggregating and separating membrane lipids.

To further facilitate removal of membranes after solubilization of the proteins, an aggregant can be added to the mixture. As discussed above, suitable compounds for aggregating membranes include polymer aggregants, such as carrageenan, algin, demethylated pectin, gum arabic, chitosan, polyethyleneimine, spermine, and spermidine. Other aggregants include salts, such as a calcium salt, magnesium salt, sulfate, phosphate, and polyamine.

Alternatively or in addition, the protein in the protein-rich supernatant can be recovered (i.e., removed from the cellular membranes) by adjusting the pH to a level at which at least some of the proteins precipitate. This pH will vary depending upon the source of the protein and can be between about 5.0 and about 7.5, e.g., between about 5.3 to about 7.3, about 5.5 to about 7.0, or about 6.0 to about 6.8, e.g., 6.8. For example, the pH can be between about 5.3 and about 5.5. The yield can be at least 70% (e.g., at least 90%) by weight of the total starting protein in the mixture. The yield is defined as the precipitated protein mass divided by the total protein mass (e.g., as determined by the Markwell method) of the starting material. Concentration of protein can be measured by any method known in the art, e.g., by the Markwell method (a modified Lowry assay). Cryoprotectants (e.g., disaccharides and/or polyalcohols, such as polysorbates) can be added to the precipitated protein to preserve and protect the product during freezing and storage.

Alternative or in addition to adjusting the pH of the solution to cause protein precipitation, polymers such as polysaccharides, charged polymers, marine hydrocolloids including alginates or carrageenan or the like, can be added, either alone or in combination with centrifugation. Such compounds can be added before, after, or instead of, adjusting the pH of the mixture to precipitate proteins. The salt concentration of the aqueous phase can also be adjusted to facilitate precipitation.

Skilled practitioners will appreciate the washes, supernatants, and flow-through fractions described above can be recycled back to earlier steps to recover even more protein using the methods. For example, after solubilized protein has been precipitated, the aqueous fraction can be entered into another batch of animal muscle that has yet to be solubilized.

Edible Protein Compositions

The methods described herein can be used to produce edible protein compositions having advantageous properties. For example, the protein compositions have a relatively low cellular membrane content. Depending upon the source (e.g., fish, beef, or chicken) of the starting material, the methods described herein can remove about 70% to 90% of cellular membranes from a sample of starting material at a relatively low centrifugation speed (e.g., 4000×g). Higher percentages can be removed using higher centrifugation speeds. Accordingly, a practitioner using the new methods can obtain protein compositions containing less than 30%, e.g., less than 25%, 20%, 15%, 10%, 5%, or 1%, or being substantially free of cellular membranes, as compared to the cellular membrane content of an equal amount of starting material.

Further, the protein compositions described above can have a cellular membrane content that is relatively resistant to oxidation. In the methods of the present invention, ions (e.g., magnesium and/or calcium) are added to a mixture containing the starting material to separate cellular membranes from cytoskeletal proteins in the material. Thereafter, lowering the pH of the mixture (e.g., to below pH 6.5) by adding acid, or adding an aggregant, to the mixture at any step of the process causes the cellular membranes to aggregate, reducing their surface area and rendering them less susceptible to oxidation. Data illustrating the reduced susceptibility of aggregated cell membranes to oxidation is provided below in Example 11. The extent to which the cellular membranes aggregate is pH- and time-dependent, i.e., a lower pH causes more rapid aggregation of membranes than does a higher pH.

Skilled practitioners will appreciate that aggregated cellular membranes are less likely to adversely affect the quality of the protein composition containing them, and that such protein compositions have an extended shelf-life. The shelf-life of such protein compositions can be extended further by any art-known method, e.g., by cooking, freezing, and/or adding antioxidants to the composition.

If aggregated, cellular membranes need not be removed from the protein composition, because the total membrane surface area is sufficiently reduced to greatly lower the rate of oxidation. Accordingly, aggregated cellular membranes can remain in the protein composition because they are less susceptible to oxidation than non-aggregated membranes. Thus, the present invention includes protein compositions having a cellular membrane content similar to that of the starting material, wherein at least a portion of the membrane content is in aggregated form and, therefore, less susceptible to oxidation than an equivalent amount of non-aggregated cellular membrane. Such protein compositions can be expected to have a 2-fold, 3-fold, 4-fold, or more, extended shelf life, as compared to raw muscle meat not processed according to the methods of the present invention. Skilled practitioners will be able to determine whether the cellular membrane content of a protein composition is wholly, or in part, in aggregated form using any art-known method, e.g., microscopy, especially in conjunction with immunological techniques.

The cellular membrane content in a protein composition prepared using the methods of the present invention can be determined using any method known to those of skill in the art. For example, total phospholipid content in the protein composition can be measured and compared to the total phospholipid content of an equal amount of untreated starting material. Similar methods were used in the working examples described below. As another example, specific membrane-associated proteins, e.g., calcium ATPase, can be used as “markers” to determine the amount of cellular membrane present in a protein composition. Total marker content can be measured in both the protein composition and the untreated starting material, and the results can be compared to determine the amount of cellular membrane remaining in the protein composition. Skilled practitioners will appreciate that there is a direct linear correlation between cellular membrane content and content of any particular membrane-associated protein. If membranes are aggregated rather than removed, this condition can be observed using a light microscope.

Use of Edible Protein

The new methods can be used to process protein from any source. For example, the methods can be used to process for human consumption materials that are not presently used as human foods due to their instability and unfavorable sensory qualities. Small pelagic species of fish such as herring, mackerel, menhaden, capelin, anchovies, or sardines are either underutilized or used for nonhuman uses. Approximately one half the fish presently caught in the world are not used for human food. A process that produces an acceptable stable protein concentrate opens the use of such material for human consumption.

The invention will be further described in the following examples, which do not limit the scope of the invention defined by the claims.

### EXAMPLES

### Example 1

### The Effect of pH on Sedimentation of Separated Membrane

The effect of pH on the sedimentation behavior of isolated muscle membranes was determined to see how differently isolated membranes behaved from those that were in the presence of solubilized protein at either high or low pH.

The isolated membranes were first prepared as follows:

1. Fish fillet was ground.

2. Four volumes of histidine buffer (0.12M KCl, 5 mM histidine, pH=7.3) were added to the ground muscle.

3. The mixture was homogenized by a Polytron® homogenizer with two bursts of 30 seconds.

4. The homogenate was centrifuged at 6,000 g for 20 minutes, and the supernatant was kept.

5. The supernatant was then centrifuged again at 50,000 g for 20 minutes. The sediment was kept after centrifugation.

6. The sediment was resuspended in 0.6 M KCl and centrifuged at 50,000 g for 20 minutes to remove actomyosin.

7. The resultant sediment was resuspended in the histidine buffer, which was defined as “membrane fraction.”

8. The concentration of proteins in the membrane fraction was measured by the Markwell method (an art-recognized, modified Lowry assay).

9. Recovery of membrane in the experiments below was determined by protein in the isolated membrane fractions and by phospholipid (PL) in the solubilized muscle preparations.

The separated membrane suspensions were adjusted to pH 3-10.5 respectively. The pH-adjusted membrane suspensions were then centrifuged at 4,000×g for 15 minutes. The remaining protein content in the resultant supernatants was measured to estimate the percent of membrane remaining in the supernatant after centrifugation. The results are tabulated in Table 1, below, and show that separated membrane can be sedimented efficiently with low pH treatment, while almost all “high pH treated membrane” remains suspended in the buffer after centrifugation.

TABLE 1
The pH Effect on Membrane Sedimentation (percent membrane
remaining in the supernatant after centrifugation).

| | pH | | | | | | | | |
|---|---|---|---|---|---|---|---|---|---|
| | 3 | 4 | 5 | 6 | 7 | 8 | 9 | 10 | 10.5 |
| % | 2.45 | 2.13 | 3.62 | 76.39 | 93.99 | 82.66 | 89.22 | 95.78 | 98.23 |

Studies of the following pH treatments were performed (centrifugation parameter is 4,000 g for 15 minutes in all cases) to investigate the low pH effect on sedimentation of separated membrane.

Treatment:

a. Start at pH 7.3, adjust to low pH (3-6), subject to centrifugation.
b. Start at pH 7.3, adjust to 10.5, adjust to low pH (3-6), subject to centrifugation.
c. Start at pH 7.3, adjust to low pH (3-6), adjust to 10.5, subject to centrifugation.

d. Start at pH 7.3, adjust to 10.5, adjust to low pH (3-6), adjust to 10.5 centrifugation.

TABLE 2
The Percent (%) of Protein Remaining in the Supernatant after
Centrifugation

low pH used

| | pH 3 | pH 4 | pH 5 | pH 6 |
|---|---|---|---|---|
| a | 2.45% | 2.13% | 3.62% | 76.39% |
| b | 2.34% | 1.53% | 3.09% | 83.27% |
| c | 8.71% | 9.79% | 13.28% | 91.95% |
| d | 8.25% | 32.58% | 82.90% | 94.09% |

TABLE 3
The Percent of Lipid Phosphorous Remaining
in the Supernatant after Centrifugation

| Low pH used | pH 3 | pH 4 | pH 5 | pH 6 |
|---|---|---|---|---|
| a | <2.00% | <2.00% | <2.00% | 68.62% |
| b | <2.00% | <2.00% | <2.00% | 75.18% |
| c | <2.00% | <2.00% | <2.00% | 82.26% |
| d | <2.00% | 31.62% | 73.76% | 94.61% |

The data above indicate that values of pH below pH 6 were effective in sedimenting the suspended membranes at 4,000×g and 15 minutes. Removal did not take place at high pH, e.g., 10.5. However, effective removal at pH 10.5 could be accomplished if the muscle protein was first treated at low pH and then brought to pH 10.5.

### Example 2

### Sedimentation of Separated Membranes Using Centrifugation

Separated membrane suspensions were first adjusted to pH 3 or 4. The pH adjusted membrane suspensions were then centrifuged at different g forces (from 500×g to 2,500×g) for 15 minutes. The remaining membrane protein content in the supernatants after different g force centrifugation was measured. The results are provided in Table 4, below.

TABLE 4
The Effect of g Force on Membrane Sedimentation

| | 2500 g | 2000 g | 1500 g | 1000 g | 500 g |
|---|---|---|---|---|---|
| pH = 3 | 2.51% | 2.88% | 5.33% | 7.01% | 29.77% |
| pH = 4 | 2.47% | 2.09% | 2.41% | 3.62% | 22.14% |

The data in Table 4 indicate that the low pH-adjusted membranes were easily sedimented from suspension by g forces as low as 1,000×g and even at 500×g.

### Example 3

### Proteins Remaining in Supernatant after Centrifugation

The SDS-PAGE (sodium dodecyl sulfate-polyacrylamide gel electrophoresis) profiles of separated membrane and membrane proteins remaining in the supernatant after low pH treatments and centrifugation were investigated. The results are tabulated in Table 5. Since the membrane studied was prepared from 100 g cod muscle tissue and the membrane protein was 108 mg, the data in the Table 5 is expressed as milligrams of protein remaining in the supernatant from the original total amount of 108 mg membrane protein prepared from 100 g cod muscle. Samples were prepared as follows:
Sample A: Membrane suspension
Sample B: Supernatant of membrane suspension after pH 7.3 to 3 to 10.5 treatment
Sample C: Supernatant of membrane suspension after pH 7.3 to 10.5 to 3 to 10.5 treatment
Sample D: Supernatant of membrane suspension after pH 7.3 to 5 treatment
Sample E: Supernatant of membrane suspension after pH 7.3 to 5 to 10.5 treatment
Sample F: Supernatant of membrane suspension after pH 7.3 to 10.5 to 5 treatment
Sample G: Supernatant of membrane suspension after pH 7.3 to 10.5 to 5 to 10.5 treatment

The protein remaining in the supernatant after pH 7.3 to 3 and 7.3 to 10.5 to 3 treatments was too little to be detected by SDS-PAGE.

TABLE 5
The Profiles of Proteins Remaining in the Supernatant after Different
Low pH Treatment.

| Mw | Sample A | Sample B | Sample C | Sample D | Sample E | Sample F | Sample G |
|---|---|---|---|---|---|---|---|
| (kDa) | (mg) | (mg) | (mg) | (mg) | (mg) | (mg) | (mg) |
| 260 | 3.24 | 2.82-3.29 | 0.24-0.40 | 0.82 | 0.43 | 0.83-0.90 | 8.95 |
| 230 | 7.56-8.64 | 0.94-1.22 | 0.48-0.56 | 0.98-1.25 | 0.57-0.71 | 0.43-0.80 | 10.74 |
| 200 | 7.56-10.8 | 0.66-1.41 | 3.21 | 0.51-0.55 | 0.71-0.85 | 0.20-0.23 | 13.4-16.2 |
| 135 | 6.48-21.6 | 1.88-2.16 | 0.96 | 1.29-1.56 | 3.56-4.27 | 0.23-0.27 | 25.1-31.4 |
| 110 | 54.0-71.3 | 0.56-0.75 | 1.77-2.01 | | 1.42 | 0.23 | 8.95 |
| 90 | 2.16-8.64 | | 0.24-0.32 | | 0.85-1.00 | 0.17-0.30 | 2.68-3.57 |
| 80 | 2.16-3.24 | | 0.40-0.56 | | 3.56-4.27 | 0.27-0.30 | 6.26 |
| 71 | 3.24-5.40 | | | | 0.43-0.71 | 0.50-0.77 | 0.89 |
| 64 | 1.08-3.24 | | | | 0.57 | | 1.78 |
| 59 | | | | | 0.43-0.71 | | |
| 45 | | | | | | | |
| 40 | | | | | | | |
| 28 | | | | | | | |
| 15 | | | | | | | |
| 10 | | | | | | | |

* 200 kD-myosin HC; 45 kD-actin; 110 kD-Ca²⁺ ATPase.

The electrophoresis results indicate that only very small amounts of membrane protein remain in the supernatant fraction after centrifugation with the exception of the sample that was treated from pH 7.3 to 10.5 to 5 to 10.5 (Sample G).

### Example 4

### Membrane Sedimentation Behavior in the Presence of pH 3 and pH 10.5 “Muscle Supernatants”

The sedimentation behaviors of muscle membranes were investigated in the presence of “muscle supernatant” (pH=3 or pH=10.5) to determine the effect of muscle proteins on membrane sedimentation.

pH 3 Procedure

The pH 3 muscle supernatants were prepared as follows:

1. Separated membrane was prepared from 250 g cod muscle tissue, and resuspended in 60 ml histidine buffer.

2. “pH 3 muscle supernatant” was prepared from 120 g cod muscle: Cod muscle was homogenized with 9 times water (citric acid is added to make a final concentration of 1 mM). The homogenate was adjusted to pH 3, and then centrifuged at 10,000 g for 30 minutes. The resulting supernatant was termed “pH 3 muscle supernatant.”

3. Volumes of 0 ml (control), 5 ml, 10 ml, 15 ml, and 20 ml of the membrane preparations were each added into five, 120 ml samples of “pH 3 muscle supernatant.” Another 10 ml membrane was added into a 120 ml sample of pH 3 HCl solution. After readjusting pH to 3.00±0.05, the mixtures are centrifuged at 4,000×g for 15 minutes. The remaining phospholipid (PL) in the resultant supernatants was measured. The experiment was performed twice. The percent added membrane remaining in the supernatant after 4,000 g centrifugation was calculated using the following formula:

$$\frac{\begin{matrix}PL remainaing in supernatant after centrifugation - \\ PL from “ muscle supernatant ”\end{matrix}}{PL from added separated membrane}$$

The data are summarized in Table 6, below.

TABLE 6
Membrane Sedimentation Behavior in the Presence of pH 3 “Muscle
Supernatants”

| | | | | | | 10 ml |
|---|---|---|---|---|---|---|
| | No | 5 ml | 10 ml | 15 ml | 20 ml | membrane |
| | membrane | membrane | membrane | membrane | membrane | added to |
| | added | added | added | added | added | pH = 3 HCl |
| PL from120 ml “muscle | 38.76 | 38.76 | 38.76 | 38.76 | 38.76 | 0 |
| supernatant” or “HCl” (mg) | | | | | | |
| Added membrane | 0 | 37.77 | 75.54 | 113.31 | 151.09 | 75.54 |
| (mg) | | | | | | |
| PL remaining in | 36.72 | 41.96 | 58.92 | 66.04 | 93.52 | 1.4 |
| supernatant after | | | | | | |
| centrifugation (mg) | | | | | | |
| Percent added membrane | | 8.47% | 26.69% | 24.07% | 36.24% | <2% |
| remaining in the | | | | | | |
| supernatant | | | | | | |

Typically, when using standard methods, at 10,000×g, 25-40% of the membranes are removed from acidified solubilized protein, i.e., 60-75% of the membranes remain in the supernatant fraction. The percentage of membrane that remained in the supernatant fractions in these experiments varied with the amount of membrane that was added. In the data presented in Table 6, 64% to 93% of the added membranes were separated at 4000×g from the muscle proteins. This is much more than would be expected to be removed from the solubilized muscle preparation. Thus, it is not simply the viscosity and the density differences between the membranes and proteins that are important in the separation step. In these experiments, previously separated membrane was added into the supernatant fraction. Although some of these membranes may have reattached to proteins, it is clear that many more did not and were easily separated. The data in Tables 6 (above) and 7 (below) therefore indicate that part of the reason it is difficult to separate membranes from solubilized proteins is that some of the interactions between the cytoskeletal proteins and the membrane fractions are not disrupted by the process of acidification. The control indicates, as before, that in the absence of proteins, essentially all of the membrane is sedimented at pH 3.

pH 10.5 Procedure

The pH 10.5 muscle supernatants were prepared as follows:

1. Separated membrane was prepared from 250 g cod muscle, and resuspended in 60 ml histidine buffer.

2. “pH 10.5 muscle supernatant” was prepared as following: 80 g cod muscle was homogenized with 9 times distilled water for 40 sec (citric acid was added to make a final concentration of 1 mM). The homogenate was adjusted to pH 10.5. The pH adjusted homogenate was centrifuged at 10,000 g for 30 minutes. The resulting supernatant was removed by pipette. The resulting supernatant was termed “pH 10.5 muscle supernatant.”

3. Volumes of 0 ml (control), 5 ml, 10 ml, 15 ml, and 20 ml of the membrane preparations were each added into five, 120 ml samples of “pH 3 muscle supernatant.” Another 10 ml membrane was added into a 120 ml sample of pH 10.5 NaOH solution. The resulting mixture was readjusted to pH 10.50±0.05. The mixtures were then centrifuged at 4,000 g for 15 minutes. The supernatant was removed. Volumes of 15 ml supernatant were removed from each sample and used to measure the PL content remaining in supernatant. The experiment was performed twice. Percent added membrane remaining in the supernatant after 4,000 g centrifugation was calculated as above.

The data are summarized in Table 7, below.

TABLE 7
Membrane Sedimentation Behavior in the Presence of pH 10.5 “Muscle
Supernatants”

| | | | | | | 10 ml |
|---|---|---|---|---|---|---|
| | | | | | | membrane |
| | No | 5 ml | 10 ml | 15 ml | 20 ml | added to |
| | membrane | membrane | membrane | membrane | membrane | pH 10.5 |
| | added | added | added | added | added | NaOH |
| PL from 120 ml | 31.80 | 31.80 | 31.80 | 31.80 | 31.80 | 0 |
| “muscle supernatant” | | | | | | |
| or “NaOH” (mg) | | | | | | |
| Added membrane (mg) | 0 | 28.66 | 57.32 | 85.78 | 114.64 | 57.32 |
| PL remaining in supernatant | 32.43 | 56.00 | 74.49 | 90.53 | 102.87 | 58.24 |
| after | | | | | | |
| centrifugation (mg) | | | | | | |
| % added membrane | | 83.74% | 74.13% | 68.23% | 61.82% | 100% |
| remaining in the | | | | | | |
| supernatant | | | | | | |

The results of adding the membrane to solubilized centrifuged protein extract at pH 10.5 are different from the results obtained at low pH. The percentage of removal ranges roughly from 18-39%. Interestingly, the higher the amount of membrane that was added, the more of it was removed by the centrifugation process. The data in Table 7 show that the presence of the solubilized muscle proteins actually improved the removal of membrane compared to the situation where there was a high pH in the absence of the muscle proteins. There was no removal of membrane by the centrifugation process in the control where no solubilized protein was used. This is consistent with the previous data.

### Example 5

### The Role of Ca²⁺

Calcium ions (Ca²⁺) were used to separate membrane fractions from proteins at g forces of 4,000 g for 15 minutes. The procedure was performed as follows:

Treatment 1: Homogenized muscle+different amount CaCl₂ solution, incubation for 1 hour, adjust pH to 3, centrifugation.

Seven 10 g cod muscle samples were each homogenized with 90 ml distilled water at speed 5 for 15 seconds. One of the seven samples was used to measure the original PL and protein in cod muscle. The other six samples had added to them different volumes of 0.5 M CaCl₂ to make the final Ca²⁺ concentration of the mixtures 0 mM (no CaCl₂ added), 0.1 mM (0.02 ml CaCl₂ added), 1 mM (0.2 ml CaCl₂ added), 5 mM (1 ml CaCl₂ added), 10 mM (2 ml CaCl₂ added), 50 mM (11 ml CaCl₂ added), respectively. After stirring, the mixtures were incubated at 0-4° C. in a cold room. After 1 hour incubation, the pH of the samples was adjusted to pH 3 before centrifugation. After centrifuging at 4,000 g for 15 minutes, the PL and protein contents remaining in the supernatants were measured.

Treatment 2. Homogenized muscle+different amount CaCl₂ solution, incubation for 1 hour, adjust pH to 10.5, centrifugation.

All the procedures for Treatment 2 were same as in Treatment 1, except the pH of samples was adjusted to 10.5 before centrifugation instead of 3.

The original PL content of cod muscle was taken as 100%, and the percentages of PL remaining in the supernatant after the various treatments with different concentrations of CaCl₂ solutions were calculated. The results are included in Table 8, below.

TABLE 8
Percent PL remaining in the Supernatant after Treatment with CaCl₂

| | No | 0.1 mM | 1 mM | 5 mM | 10 mM | 50 mM |
|---|---|---|---|---|---|---|
| | Ca²⁺ | Ca²⁺ | Ca²⁺ | Ca²⁺ | Ca²⁺ | Ca²⁺ |
| Treatment 1 | 65.47% | 61.50% | 57.30% | 46.07% | 29.07% | 27.30% |
| Treatment 2 | 74.29% | 73.40% | 49.37% | 45.82% | 37.98% | 10.36% |

Next, the original protein content of cod muscle was taken as 100%, and the percentages of protein remaining in the supernatant after the various treatments with different concentrations of CaCl₂ solutions were calculated. The results are included in Table 9, below.

TABLE 9
Percent Protein remaining in the Supernatant after Treatment with
CaCl₂

| | No | 0.1 mM | 1 mM | 5 mM | 10 mM | 50 mM |
|---|---|---|---|---|---|---|
| | Ca²⁺ | Ca²⁺ | Ca²⁺ | Ca²⁺ | Ca²⁺ | Ca²⁺ |
| Treatment 1 | 91.97% | 90.23% | 86.83% | 86.39% | 88.27% | 87.09% |
| Treatment 2 | 92.69% | 91.44% | 90.67% | 91.44% | 88.29% | 49.45% |

The data in Tables 8 and 9 indicate that calcium has a positive effect on removal of membranes from the solubilized muscle proteins at both acid pH (3) or at alkaline pH (10.5). Native concentrations of calcium which would be between about 0.1 and 1 mM did not greatly lower the amount of phospholipid at pH 3, but performed moderately well at pH 10.5. Higher concentrations, e.g., 10 mM Ca²⁺, removed a considerable amount of the membrane from the solution. Fifty mM performed even better at the alkaline pH, but it also began to remove some of the muscle proteins.

### Example 6

### Effect of Incubation Time and Ca²⁺ Concentration on Membrane Removal

The effect of incubation time with Ca²⁺ before solubilization of the muscle proteins at acid pH was investigated. Two concentrations of Ca²⁺ were used, 10 mM and 50 mM which are effective in removing the membrane.

Eight 10 g ground cod samples were weighed and 0.02 g citric acid was added to each sample. The samples were homogenized with 90 ml cold distilled water at 5 speed for 25 seconds. One of the eight samples was used to measure the original PL and protein in cod muscle. The other seven samples were treated as follows: (1) 0 ml, 2 ml, 11 ml 0.5 M CaCl₂ was added to three samples (making the concentration of Ca to be 0 mM, 10 mM, 50 mM), the pH of the three samples was adjusted to 3 (0 minutes) as quickly as possible and centrifuged at 4,000 g for 15 minutes. (2) 2 ml, 11 ml Ca were added to two samples. The samples were then incubated for 30 minutes before adjusted to pH 3 and centrifugation (3) 2 ml, 11 ml Ca were added to the other two samples. After 60 minutes of incubation, the pH of the samples was adjusted to pH 3 and the samples were then centrifuged at 4,000 g for 15 minutes. For all treatments, the PL and protein contents remaining in the supernatants were measured after centrifugation.

The treatments can be summarized as follows:

Treatment (a): Homogenize muscle (citric acid added before homogenization), add CaCl₂ to make the concentration of Ca²⁺ 10 mM and 50 mM, incubate for 0 minutes, adjust to pH 3, centrifuge.

Treatment (b): Homogenize muscle (citric acid added before homogenization), add CaCl₂ to make the concentration of Ca²⁺ 10 mM and 50 mM, incubate for 30 minutes, adjust to pH 3, centrifuge.

Treatment (c): Homogenized muscle (citric acid added before homogenization), add CaCl₂ to make the concentration of Ca²⁺ 10 mM and 50 mM, incubate for 60 minutes, adjust to pH 3, centrifuge.

The original PL content of cod muscle was taken as 100%, and the percentages of PL remaining in the supernatant after each treatment was calculated. The results are included in Table 10, below.

TABLE 10
Percentages of PL Remaining in the Supernatant

| | No Ca²⁺ | 10 mM Ca²⁺ | 50 mM Ca²⁺ |
|---|---|---|---|
| Treatment a | 66.50% | 43.38% | 19.81% |
| Treatment b | | 26.71% | 19.50% |
| Treatment c | | 19.27% | 19.32% |

Next, the original protein content of cod muscle was taken as 100%, and the percentages of protein remaining in the supernatant after each treatment was calculated. The results are included in Table 11, below.

TABLE 11
Percentages of Protein Remaining in the Supernatant

| | No Ca²⁺ | 10 mM Ca²⁺ | 50 mM Ca²⁺ |
|---|---|---|---|
| Treatment a | 90.31% | 84.12% | 69.05% |
| Treatment b | | 82.72% | 71.40% |
| Treatment c | | 81.32% | 71.76% |

The pH value at the moment just before pH 3 adjustment (the original cod homogenized muscle pH=7.1) was determined. The results are included in Table 12, below.

TABLE 12
pH value before adjustment

| | No Ca²⁺ | 10 mM Ca²⁺ | 50 mM Ca²⁺ |
|---|---|---|---|
| Treatment a | 6.52 | 6.20 | 5.92 |
| Treatment b | | 6.22 | 5.95 |
| Treatment c | | 6.17 | 5.99 |

The data above indicates that centrifugation in the absence of calcium removed less than 40% of the membrane in the solutions of muscle proteins. When 10 mM Ca²⁺ was added, the effectiveness of the removal was time-dependent, being approximately 57% when there was no incubation, 73% with 30 minutes incubation, and over 80% with 60 minutes incubation. A similar removal of membrane was achieved with 50 mM Ca²⁺ to that achieved after 60 minutes with 10 mM Ca²⁺, irrespective of the time of incubation. It should be noted that a 0 minute incubation does not mean 0 minutes of contact between the calcium and the material since it takes some time to adjust the pH to a low value. The protein content removed at 10 mM Ca²⁺ was greater than that at which there was no calcium, and was less than what was removed with 50 mM Ca²⁺. These techniques, particularly those at alkaline pH, may serve as a fractionation procedure for the protein. High concentrations of calcium may precipitate some of the proteins at both low and high pH values. The specific proteins enriched in the precipitates prepared in this way may provide unique functional properties. Unlike the case with membrane removal as determined by phospholipid concentration, the removal of protein did not have any significant time dependency. Increasing amounts of Ca²⁺ lowered the pH somewhat.

### Example 7

### Effect of Calcium in the Absence of Citric Acid at Acid pH

The effect of calcium in the absence of citric acid at acid pH was investigated. Ground cod samples (10 g each sample) were homogenized with 90 ml cold distilled water at 5 speed for 25 seconds. One of the samples was used to measure the original PL and protein in cod muscle. Calcium was added to the samples, making three sets of samples with calcium concentrations at 0 mM, 0.1 mM, 1 mM, 5 mM, 10 mM, 50 mM in each set. Three sets were incubated for 0 min, 30 min, and 60 min, respectively, before adjusting the pH to 3. The pH adjusted samples were centrifuged at 4,000 g for 15 minutes. For all treatments, the PL and protein contents remaining in the supernatants were measured after centrifugation. The treatments are summarized below.

Treatment (a): Homogenize muscle (No citric acid added), add CaCl₂ to make the concentration of Ca²⁺ 0.1 mM, 1 mM, 5 mM, 10 mM, 50 mM, incubate for 0 minutes, adjust to pH 3, centrifuge.

Treatment (b): Homogenize muscle (No citric acid added), add CaCl₂ to make the concentration of Ca²⁺ 0.1 mM, 1 mM, 5 mM, 10 mM, 50 mM, incubate for 30 minutes, adjust to pH 3, centrifuge.

Treatment (c): Homogenize muscle (No citric acid added), add CaCl₂ to make the concentration of Ca²⁺ 0.1 mM, 1 mM, 5 mM, 10 mM, 50 mM, incubate for 60 minutes, adjust to pH 3, centrifuge.

The original PL content of cod muscle was taken as 100%, and the percentages of PL remaining in the supernatant after each treatment was calculated. The results are included in Tables 13, below.

TABLE 13
Percentages of PL Remaining in the Supernatant

| | 0 mM | 0.1 mM | 1 mM | 5 mM | 10 mM | 50 mM |
|---|---|---|---|---|---|---|
| a | 89.60% | 86.03% | 85.64% | 80.63% | 64.54% | 51.45% |
| b | 91.83% | 89.47% | 85.24% | 78.53% | 64.05% | 55.67% |
| c | 90.88% | 85.83% | 85.16% | 77.96% | 65.50% | 54.20% |

Next, the original protein content of cod muscle was taken as 100%, and the percentages of protein remaining in the supernatant after each treatment was calculated. The results are included in Table 14, below.

TABLE 14
Percentages of Protein Remaining in the Supernatant

| | 0 mM | 0.1 mM | 1 mM | 5 mM | 10 mM | 50 mM |
|---|---|---|---|---|---|---|
| a | 95.35% | 94.78% | 93.23% | 94.39% | 94.42% | 86.89% |
| b | 95.23% | 94.37% | 93.43% | 92.00% | 92.16% | 87.73% |
| c | 97.61% | 97.42% | 92.40% | 91.50% | 92.91% | 88.32% |

The pH value at the moment just before pH 3 adjustment (the original cod homogenized muscle pH=7.1) was determined. The results are included in Table 15, below.

TABLE 15
pH Value before Adjustment

| | 0 mM | 0.1 mM | 1 mM | 5 mM | 10 mM | 50 mM |
|---|---|---|---|---|---|---|
| pH | 7.19 | 7.08 | 6.95 | 6.74 | 6.60 | 6.50 |

The data above indicate that treatments with CaCl₂ gave some improvement with increasing Ca²⁺ concentration, which was not time-dependent. Membrane removal is improved even further when the process is carried out in the presence of citric acid.

### Example 8

### The Effect of Citric Acid

Whether the membrane sedimentation effect was due to citric acid or simply H⁺ provided by the citric acid was investigated. Nine 10 g ground cod samples were weighed. 0.02 g citric acid was added to four of the nine samples. The samples were homogenized with 90 ml cold distilled water at 5 speed for 25 seconds. One of the nine samples (no citric acid added) was used to measure the original PL and protein in cod muscle. The other eight samples were treated as follows: (1) For the four samples without adding citric acid, HCl was added to adjust their pH to 6.50. One of them was adjusted to pH 3 immediately to act as a control. Two ml of 0.5 M CaCl₂ was added to the other three samples (making the concentration of Ca²⁺ 10 mM), and then incubated for 0, 30, and 60 minutes before adjusting the pH to 3.

(2) For the four samples with citric acid added (pH around 6.50), one of them was adjusted to pH 3 immediately to act as control. Two ml of 0.5 M CaCl₂ was added to the other three samples (making the concentration of Ca²⁺ to be 10 mM), and then incubated for 0 minutes, 30 minutes, 60 minutes before adjusting to pH 3. All the resultant samples were centrifuged at 4,000 g for 15 minutes. For all the treatments, the PL and protein contents remaining in the supernatants were measured after centrifugation. The treatments used in the investigation are summarized below.

Treatment (a) (with citric acid): Homogenize muscle (20 mg citric acid added before homogenization, which made the pH of homogenized muscle to be around 6.50), add CaCl₂ solution to make the concentration of Ca²⁺ 10 mM, incubate for 0 minutes, 30 minutes, 60 minutes, adjust to pH 3 by HCl, centrifuge.

Treatment (b) (without citric acid): Homogenize muscle, adjust the pH of homogenized muscle to 6.50 with HCl, add CaCl₂ solution to make the concentration of Ca²⁺ 10 mM, incubate for 0 minutes, 30 minutes, 60 minutes, centrifuge.

The original PL content of cod muscle was taken as 100%, and the percentages of PL remaining in the supernatant after each treatment was calculated. The results are included in Tables 16, below.

TABLE 16
Percentages of PL Remaining in the Supernatant

| Incubation | No ions | | | |
|---|---|---|---|---|
| time | control | 0 min | 30 min | 60 min |
| Treatment A | 69.65% | 60.12% | 57.96% | 60.92% |
| Treatment B | 68.00% | 31.67% | 28.28% | 25.55% |

Next, the original protein content of cod muscle was taken as 100%, and the percentages of protein remaining in the supernatant after each treatment was calculated. The results are included in Table 17, below.

TABLE 17
Percentages of Protein Remaining in the Supernatant

| Incubation | No Ca | | | |
|---|---|---|---|---|
| time | control | 0 min | 30 min | 60 min |
| Treatment A | 94.90% | 93.68% | 90.82% | 88.06% |
| Treatment B | 92.69% | 84.96% | 85.77% | 83.30% |

With regard to pH, the pH of the homogenized muscle was 7.10. Before adding Ca²⁺ (lowered by citric acid or HCl) the pH was 6.50. After adding Ca²⁺ (2 ml 0.5M Ca²⁺), the pH was 6.20. The data indicates that efficient removal of membrane from the solubilized muscle solution depends not just on the H⁺ concentration (pH), but also on the acid utilized.

### Example 9

### The Role of Mg⁺²

The membrane sedimentation effect of MgCl₂ was investigated. Five 10 g ground cod samples were weighed. 0.02 g citric acid was added to four of the five samples. The samples were homogenized with 90 ml cold distilled water at 5 speed for 25 seconds. One of the five samples (no citric acid added) was used to measure the original PL and protein in cod muscle. The other four samples were treated as follows: (1) one sample (control): adjusted to pH 3 by HCl; (2) three samples: added 2 ml 0.5M MgCl₂ to make the concentration of Mg 10 mM, incubated for 0 minutes, 30 minutes, 60 minutes respectively. After incubation, all samples were adjusted to pH 3. All samples were centrifuged at 4,000 g for 15 minutes. For all the treatments, the PL and protein contents remaining in the supernatants were measured after centrifugation. The treatment used in the investigation is summarized below.

Treatment: Homogenized muscle (20 mg citric acid added before homogenization, which made the pH of homogenized muscle to be around 6.50-6.60), add MgCl₂ solution to make the concentration of Mg 10 mM, incubate for 0 minutes, 30 minutes, 60 minutes, adjust to pH 3 by HCl, centrifuge.

The original PL content of cod muscle was taken as 100%, and the percentages of PL remaining in the supernatant after each treatment was calculated. The results are included in Tables 18, below.

TABLE 18
Percentages of PL Remaining in the Supernatant

| Incubation | | | | |
|---|---|---|---|---|
| time | No Mg control | 0 min | 30 min | 60 min |
| Mg Treatment | 66.50% | 52.73% | 35.56% | 34.09% |

Next, the original protein content of cod muscle was taken as 100%, and the percentages of protein remaining in the supernatant after each treatment was calculated. The results are included in Table 19, below.

TABLE 19
Percentages of Protein Remaining in the Supernatant

| Incubation | | | | |
|---|---|---|---|---|
| time | No Mg control | 0 min | 30 min | 60 min |
| Mg Treatment | 90.72% | 91.03% | 88.78% | 87.63% |

These data indicate that magnesium ion has a time-dependent effect on removal of membrane from the solubilized muscle proteins at pH 3. Time-dependency is clearer than it was in the case of calcium, whereas the percent removal (about 65% after 30 and 60 minutes) was somewhat less than is typically removed in the presence of CaCl₂.

### Example 10

### Effect of Ca²⁺ and Mg²⁺ Added after Solubilization of Proteins at pH 3

The effect of adding calcium and magnesium chlorides after adjusting the solubilized proteins to pH 3 in the presence of citric acid, rather than before solubilization, was investigated. Eight 10 g ground cod samples were weighed. 0.02 g citric acid was added to seven of the eight samples. The samples were homogenized with 90 ml cold distilled water at 5 speed for 25 seconds One of the eight samples (no citric acid added) was used to measure the original PL and protein in cod muscle. The other seven samples were treated as follows: (1) one sample (Control): adjusted to pH 3 with HCl, then centrifuged; (2) three samples: adjusted pH 3 with HCl, then added 2 ml 0.5 M MgCl₂ to make the concentration of Mg²⁺ 10 mM, incubated for 0 minutes, 30 minutes, 60 minutes before centrifuging; (3) three samples: adjusted to pH 3 with HCl, then added 2 ml 0.5 M CaCl₂ to make the concentration of Ca²⁺ 10 mM, incubated for 0 minutes, 30 minutes, 60 minutes, respectively before centrifuging. All samples were centrifuged at 4,000 g for 15 min. For all the treatments, the PL and protein contents remaining in the supernatants were measured after centrifugation. The treatments used in the investigation are summarized below.

Treatment (a): Homogenize muscle (20 mg citric acid added before homogenization, which made the pH of homogenized muscle to be around 6.50), adjust to pH 3 with HCl, add MgCl₂ solution to make the concentration of Mg 10 mM, incubate for 0 minutes, 30 minutes, 60 minutes, centrifuge.

Treatment (b): Homogenize muscle (20 mg citric acid added before homogenization, which made the pH of homogenized muscle to be around 6.50), adjust to pH 3 with HCl, add CaCl₂ solution to make the concentration of Ca 10 mM, incubate for 0 minutes, 30 minutes, 60 minutes, centrifuge.

The original PL content of cod muscle was taken as 100%, and the percentages of PL remaining in the supernatant after each treatment was calculated. The results are included in Table 20, below.

TABLE 20
Percentages of PL Remaining in the Supernatant

| Incubation | No ions | | | |
|---|---|---|---|---|
| time | control | 0 min | 30 min | 60 min |
| Treatment A | 74.50% | 74.10% | 70.36% | 72.25% |
| Treatment B | 74.50% | 69.38% | 72.31% | 71.21% |

Next, the original protein content of cod muscle was taken as 100%, and the percentages of protein remaining in the supernatant after each treatment was calculated. The results are included in Table 21, below.

TABLE 21
Percentages of Protein Remaining in the Supernatant

| Incubation | No Ca | | | |
|---|---|---|---|---|
| time | control | 0 min | 30 min | 60 min |
| Treatment A | 92.35% | 91.92% | 90.93% | 88.66% |
| Treatment B | 92.35% | 88.74% | 89.15% | 90.90% |

The data above indicate that the addition of CaCl₂ or MgCl₂ solutions to the solubilized muscle proteins at acidic pH did not remove the membrane fraction.

### Example 11

### Aggregated Cellular Membranes Exhibit Reduced Susceptibility to Hemoglobin-Catalyzed Oxidation

Whether aggregation of cellular membranes renders them resistant to hemoglobin-catalyzed oxidation was investigated. The results of the experiments are provided in Tables 22 and 23, below.

Fish Supply

Cod fish (Gadus morhua) was obtained from day boats in Gloucester, Mass. The fish was transported in ice to the laboratory and was filleted, skinned, and minced. All dark muscle was removed.

Isolated Membrane Model System

The method of McDonald and Hultin (J. Food Sci. 52, 15-21 (1987)) was modified for isolating membranes. Four volumes of a cold 0.1 M HEPES buffer (pH 7.5) were added to the minced muscle and homogenized using a Polytron® PT 10-35 (Brinkman Instruments, Westbury, N.Y.) for 30 seconds at speed 5. The pH of the homogenate was adjusted to 7.5 and centrifuged at 10,000×g for 20 minutes at 5-10° C. in a Beckman L8-55M Ultracentrifuge (Beckman Instruments, Palo Alto, Calif.). The supernatant was recentrifuged at 130,000×g for 30 minutes at 5-10° C. The resulting sediment was suspended in a cold 0.12 M KCL and 5 mM histidine (pH 6.8) buffer with a Potter homogenizer and stored at −80° C. for no longer than one week.

The model system was formed with a final concentration of 0.7 mg of membrane protein/ml in 0.12 KCL and 5 mM histidine to the pH values indicated. Incubations were carried out in a shaking water bath at 6° C. in air in 25 ml Erlenmeyer flasks. Reactions were initiated by the addition of hemoglobin. The pH was adjusted before adding hemoglobin and it was checked after adding hemoglobin.

Membranes of Washed Cod Model System

The washed cod muscle was prepared by an adaptation of the procedure of Richards and Hultin (2000). A 50 mM sodium phosphate, 0.12 M KCL and 5 mM histidine solution were used in the washed cod to modify ionic strength and modify pH. The final washed cod was frozen at −80° C. The muscle was thawed in a sealed plastic bag under running cold water. After the pH was adjusted, the moisture was measured. Streptomycin sulfate (200 ppm) was added to inhibit microbial growth. The final moisture was adjusted to 88%. A volume of hemoglobin stock solution was added to a final concentrate of 3 μmol per kg of washed cod muscle. In the control the hemoglobin solution was replaced by distilled water. The samples were incubated at 2° C.

Preparation of Cod Hemolysate

The cod blood was collected from cod frames obtained after filleting in the rigor state. The blood was taken from the caudal vein after the tail of the fish frame was cut off. Fish blood was drawn from the opened caudal vein by using a transfer glass pipette rinsed with 150 mM NaCl with sodium heparin solution (30 units/ml). The blood was immediately mixed with approximately 1 volume of saline sodium heparin solution. Hemolysate was prepared following the procedure of Fyhn et al. (Comp. Biochem. Physiol. 62A, 39-66 (1979)) modified by Richards and Hultin (J. Agric. Food Chem. 4, 314103147 (2000)). Four volumes of ice-cold 290 mM NaCl in 1 mM Tris, pH 8.0, were added to heparinized blood. Centrifugation was done at 700×g for 10 min at 4° C. using a table top clinical centrifuge (IEC, Needham Heights, Mass.). Plasma was then removed. Red cells were washed by suspending three times in 10 volumes of the above buffer and centrifuging at 700×g. Cells were lysed in 3 volumes of 1 mM Tris, pH 8.0 for 1 h. One-tenth volume of 1 M NaCl was then added to aid in stromal removal before centrifugation at 28,000×g for 15 min at 4° C. in a Beckman Ultracentrifuge Model L5-65B (Beckman Instruments Inc., Palo Alto, Calif.). Hemolysate was stored at −80° C.

Hemoglobin (Hb) levels were quantified with modifications of the method of Brown (J. Biol. Chem. 236, 2238-2240 (1961)). Approximately 1 mg of sodium dithionite was added to the extract and mixed in a cuvette. Then the sample was bubbled with carbon monoxide gas (Matheson Gas, Gloucester, Mass.) for 30 sec. The sample was then scanned from 440 to 400 nm (Soret) against a blank that contained only buffer using a Model U-3110 double-beam spectrophotometer (Hitachi Instruments, Inc., San Jose, Calif.). The peak was recorded. Standard curves were constructed using bovine hemoglobin standard in 50 mM Tris, pH 8.6 buffer on 50 mM Tris, 200 mM NaCl, pH 6.95 buffer. In a separate procedure, when very low levels of hemoglobin were present, a portion of the extract was mixed with approximately 1 mg sodium dithionite in a cuvet. The sample was immediately scanned spectrophotometrically against a reference with no sodium dithionite. The difference in absorbance of the peak (432 nm) and valley (410 nm) of the spectrum was used to measure hemoglobin.

Thiobarbituric Acid Reactive Substances (TBARS) Analyses

Thiobarbituric acid reactive substances (TBARS) were determined using a muscle extraction procedure in which EDTA (0.1%) and propyl gallate (0.1%) were added to the extraction solution (7.5% trichloroacetic acid, TCA) to lessen development of TBARS during the analytical procedure. A modification included using 1 g of sample and extracting with 6 ml of TCA solution by homogenization with a Tissue Tearor™ model 986-370 at high speed (Biospec Products Inc., Bartlesville, Okla.). For the standard curve an extinction coefficient of 1.30×10⁵ M⁻¹cm⁻¹ was determined using tetraethoxypropane standard. The TBARS data are expressed as μmol malonaldehyde per kg tissue or per kg lipid.

Determination of Protein Content

Protein content was determined by the method of Markwell et al. (Anal. Biochem. 87, 206-210 (1978)). Bovine albumin was used.

Table 24, below, demonstrates that hemoglobin-catalyzed oxidation of isolated cod sarcoplasmic reticulum lipids is slowest at pH 3.5. This is in contrast to what was observed in washed cod muscle where the oxidation is rapid at acid pH values up to 6.8 (see Table 23, below). The last column in Table 22 shows that even after re-adjusting the pH to 8 from 3.5, a large proportion of the antioxidation effectiveness is retained. As indicated in other examples described above, acid pH isolated membrane is sedimented easily at low centrifugal force, indicating that the membranes are aggregated.

TABLE 22
Effect of pH on Hemoglobin-Catalyzed Oxidation of Isolated Cod
Sarcoplasmic_Reticulum Lipids

| | pH, TBARS as nmol MDA/mg membrane proteins | | | | | |
|---|---|---|---|---|---|---|
| time (h) | 3.5 | 4.5 | 6.0 | 6.8 | 8.0 | 3.5¹ increase to 8.0 |
| 0 | 0 | 0 | 0 | 0 | 0 | 0 |
| 1.5 | 0 | 2.7 | 1.3 | 10.2 | 31 | 1.8 |
| 2.5 | 0.8 | 20.6 | 22.6 | 78.3 | 72 | 6.4 |
| 3.0 | 0 | 18.8 | 66.0 | 87.6 | 80.1 | 8.1 |
| 3.5 | 7.5 | 36.4 | 88.8 | 95.0 | 83.3 | 12.6 |
| 4.0 | 15.6 | 49.8 | 97.5 | 97.6 | 84.0 | 26.6 |
| 5.0 | 27.8 | 64.9 | 108.5 | 101.7 | 85.2 | 53.4 |
| 6.0 | 57.8 | 87.8 | 112.8 | 99.4 | 85.5 | 51.7 |

¹Membranes were stored for 30 minutes at pH 3.5 before being brought to pH 8.0. 6 μM hemoglobin was added at a temperature of 2° C.
MDA = malonaldehyde.

TABLE 23
Effect of pH on Hemoglobin-Catalyzed Oxidation of the Cod
Membrane Lipids of Washed Cod Muscle

pH, TBARS as μmol MDA/kg washed cod

| time, h | 3.5 | 6.8 | 7.6 | 3.5¹ increase to 8.0 |
|---|---|---|---|---|
| 0 | 5.7 | 0 | 0 | 4.9 |
| 6 | 185.0 | 193.8 | 5.3 | 18.2 |
| 12 | 267.1 | 273.6 | 62.3 | 59.6 |
| 16 | 273.2 | 285.5 | 141.0 | 81.5 |
| 28 | 262.0 | 269.5 | 261.8 | 155.9 |
| 43 | 283.3 | 300.7 | 257.8 | 167.7 |

¹Washed cod was stored at pH 3.5 for 1.5 h before adjusting to pH 7.6. 3 μM hemoglobin was used. Other conditions as in Table 22.

Table 23 demonstrates that the non-isolated cellular membranes of washed cod muscle oxidize rapidly at acid pH values up to 6.8.

The model systems used in the present example are recognized in the art as involving “accelerated” oxidation conditions. The oxidation conditions are “accelerated” because the systems are free of natural antioxidants and include a high concentration of added pro-oxidant (hemoglobin). Accordingly, membrane oxidation in the accelerated system will occur more rapidly than it would in a non-accelerated (i.e., natural) system. Skilled practitioners will appreciate, however, that the relative rates of oxidation in accelerated and non-accelerated systems are similar. For example, a four-fold decrease in the rate of oxidation in the accelerated system would correspond to an approximately four-fold decrease in the rate of oxidation in a non-accelerated (i.e., natural) system.

Skilled practitioners will recognize that the data presented above suggest that aggregated cellular membranes are substantially less prone to oxidation than non-aggregated membranes, and that protein compositions possessing such oxidation-resistant membranes may have an extended shelf-life as compared to protein compositions containing readily-oxidizable membranes.

### Other Embodiments

A number of embodiments of the invention have been described. Nevertheless, it will be understood that various modifications may be made without departing from the spirit and scope of the invention. Accordingly, other embodiments are within the scope of the following claims.

1. A method of preparing an edible protein composition with reduced oxidation protential from animal muscle, the method comprising:
(a) obtaining a mixture comprising minced or ground animal muscle;
(b) adding an amount of a polyvalent, food-grade cation to the mixture sufficient to separate cellular membranes from cytoskeletal proteins in the animal muscle; and
(c) treating the mixture to reduce the oxidation potential of the separated cellular membranes.

2. The method of claim 1, wherein the polyvalent, food-grade cations are calcium or magnesium ions, and wherein the concentration of calcium or magnesium ions in the mixture is in a range of about 0.1 mM to about 50 mM after the addition.

3. The method of claim 1, wherein step (c) comprises aggregating at least a portion of the separated cellular membranes in the mixture to reduce the total separated membrane surface area, thereby reducing the oxidation potential.

4. The method of claim 3, further comprising (d) dewatering the mixture.

5. The method of claim 1, wherein step (c) comprises removing the separated cell membranes from the mixture, thereby reducing the oxidation potential.

6. The method of claim 1, wherein step (c) comprises incubating the mixture to allow the separated membranes to aggregate, thereby reducing the oxidation potential, and wherein the method further comprises (d) adjusting the pH of the mixture to solubilize at least a portion of the protein in the mixture.

7. The method of claim 6, further comprising (e) removing the aggregated separated cell membranes from the solubilized protein.

8. The method of claim 7, further comprising (f) collecting the solubilized protein.

9. The method of claim 3, wherein step (c) comprises adding an acid to the mixture.

10. The method of claim 6, wherein step (d) comprises adding an acid to the mixture.

11. The method of claim 9, wherein sufficient acid is added to the mixture to lower the pH to below about 3.5.

12. The method of claim 6, wherein step (d) comprises adding a base to the mixture.

13. The method of claim 12, wherein sufficient acid is added to the mixture to raise the pH to greater than about 10.0.

14. The method of claim 1, wherein the polyvalent food-grade cation is calcium chloride.

15. The method of claim 1, wherein the polyvalent food-grade cation is magnesium chloride.

16. The method of claim 1, wherein step (c) comprises incubating the mixture for up to 60 minutes following step (b).

17. The method of claim 1, further comprising adding an organic acid to the mixture before, during, or after step (b).

18. The method of claim 17, wherein the organic acid is selected from the group consisting of citric, malic, maleic, fumaric, and tartaric acid.

19. The method of claim 7, wherein step (e) is performed by centrifugation.

20. The method of claim 19, wherein the centrifugation is performed at from about 500×g to about 10,000×g.

21. The method of claim 7, wherein step (e) is performed by precipitation.

22. The method of claim 3, wherein aggregating is performed by adding to the mixture an aggregant selected from the group consisting of carrageenan, algin, demethylated pectin, gum arabic, chitosan, polyethyleneimine, spermine, spermidine, calcium salt, magnesium salt, sulfate, phosphate, and polyamine.

23. The method of claim 6, wherein step (c) further comprises adding to the mixture an aggregant selected from the group consisting of carrageenan, algin, demethylated pectin, gum arabic, chitosan, polyethyleneimine, spermine, spermidine, calcium salt, magnesium salt, sulfate, phosphate, and polyamine.

24. The method of claim 4, wherein dewatering is performed by centrifuging the mixture.

25. The method of claim 4, wherein dewatering is performed by filtering the mixture.

26. The method of claim 4, wherein dewatering is performed by pressing the mixture.

27. The method of claim 1, further comprising homogenizing the animal muscle between steps (a) and (b).

28. The method of claim 1, wherein step (b) and (c) are performed simultaneously by adding a sufficient amount of calcium or magnesium ions to cause both separation of cellular membranes and cytoskeletal proteins and aggregation of the membranes.

29. An edible protein composition with reduced oxidation potential comprising minced or ground animal muscle, wherein the composition comprises a cellular membrane content of less than 40% of a cellular membrane content in a sample of the animal muscle as removed from the animal prior to mincing or grinding.

30. The edible protein composition of claim 29, wherein the protein composition has a cellular membrane content less than 25% of that in the animal muscle.

31. The edible protein composition of claim 29, wherein the protein composition has a cellular membrane content less than 20% of that in the animal muscle.

32. The edible protein composition of claim 29, wherein the protein composition has a cellular membrane content less than 10% of that in the animal muscle.

33. The edible protein composition of claim 29, wherein the protein composition has a cellular membrane content less than 5% of that in the animal muscle.

34. An edible protein composition with reduced oxidation potential comprising minced or ground animal muscle, wherein the composition comprises a cellular membrane content approximately equal to the cellular membrane content in a sample of the animal muscle as removed from the animal prior to mincing or grinding, wherein at least 60% of the cellular membranes in the edible protein composition are separated from cytoskeletal proteins and are in aggregated form, as determined using microscopy.

35. An edible protein composition with reduced oxidation potential produced by the process of claim 1.
